(19) United States
(12) Patent Application Publication
(10) Pub. No.: US 2007/0003651 A1
(43) Pub. Date: Jan. 4, 2007

(54) Mold for pressurizing foamable material

(76) Inventors: Ming Hsiu Chung, Chung Li (TW); Shia Chung Chen, Taoyuan City (TW); Shyh Shin Hwang, Taoyuan City (TW)

Correspondence Address: CHARLES E. BAXLEY, ESQ., 90 JOHN STREET, THIRD FLOOR, NEW YORK, NY, 10038, US

(21) Appl. No.: 11/171,553

(22) Filed: Jun. 30, 2005

(51) Int. Cl. A23G 1/22

(52) U.S. Cl. 425/117

(57) ABSTRACT

A mold device includes a mold member having a mold cavity for receiving a melted foamable material to form an object, and a pressure applying device for applying a pressure to the melted foamable material, and to limit a foaming of the melted foamable material, and for preventing orifices from being formed in an outer peripheral portion of the object, and for forming a smooth and shiny or sparkling outer appearance to the object. A mold piece is movably received in the mold cavity, and an actuator may force the mold piece to force against the melted foamable material. A pumping device may pump the hydraulic fluid into and out of the actuator.

### BACKGROUND OF THE INVENTION

1. Field of the Invention

The present invention relates to a mold device, and more particularly to a mold device having a structure arranged for pressurizing foamable materials, and for preventing the foamable materials from being over foamed, and for preventing perforations or orifices from being formed in the outer peripheral portion of the objects to be formed or made with the foamable materials.

2. Description of the Prior Art

Typical mold devices comprise one or more mold pieces including one or more mold cavities formed or provided therein, for receiving injected plastic or foamable materials therein, and for forming various objects, such as shoes, board or sheet members, or other objects.

For example, U.S. Pat. No. 4,309,376 to Ueno et al., and U.S. Pat. No. 4,605,455 to Lai, and U.S. Pat. No. 5,667,737 to Wittmann disclose three of the typical mold devices each also comprising one or more mold cavities formed or provided therein and defined by one or more mold pieces, for receiving various injected or molded plastic or foamable materials therein, and to form various objects.

Normally, the mold cavities of the mold devices are emptied to receive the injected or molded plastic or foamable materials therein, and the typical mold devices may not apply any forces to or against the plastic or foamable materials that are filled or injected into the mold cavities of the mold devices, and may only let the plastic or foamable materials to foam or to expand without being limited, such that the plastic or foamable materials may be over foamed or may be over expanded in some circumstances.

For example, when the plastic or foamable materials are heated to make or to form various objects, and when the plastic or foamable materials may be over foamed or may be over expanded, some of the air bubbles generated within the plastic or foamable materials, during the foaming procedures, may be broken to form perforations or holes or orifices or cavities in the outer peripheral surfaces of the objects, and may spoil the outer appearances of the objects, particularly when the objects are required to have a smooth and shiny or sparkling outer appearance.

The present invention has arisen to mitigate and/or obviate the afore-described disadvantages of the conventional mold devices.

### SUMMARY OF THE INVENTION

The primary objective of the present invention is to provide a mold device including a structure arranged for pressurizing foamable materials, and for preventing the foamable materials from being over foamed, and for preventing perforations or orifices from being formed in the outer peripheral portion of the objects to be formed or made with the foamable materials.

In accordance with one aspect of the invention, there is provided a mold device comprising a mold member including a mold cavity formed therein for receiving a melted foamable material therein to form an object, and a pressure applying device for applying a pressure to the melted foamable material, and to limit a foaming of the melted foamable material, and for preventing orifices from being formed in an outer peripheral portion of the object, and for forming a smooth and shiny or sparkling outer appearance to the object.

The pressure applying device includes a mold piece movably received in the mold cavity of the mold member, to form a chamber between the mold member and the mold piece, and for receiving the melted foamable material therein.

The mold member includes a pouring passage formed therein and communicating with the chamber formed between the mold member and the mold piece, and having a pouring spout provided therein for receiving and filling the melted foamable material into the chamber formed between the mold member and the mold piece.

The pressure applying device includes an actuator engageable with the mold piece, for forcing the mold piece to force against the melted foamable material. The actuator includes a housing having a compartment formed therein for receiving a hydraulic fluid therein, and a shank slidably received in the compartment of the housing and engageable with the mold piece, for forcing against the mold piece, and then onto the melted foamable material.

The pressure applying device includes a pumping device coupled to the compartment of the housing, for pumping the hydraulic fluid into and out of the compartment of the housing. The pumping device includes a receptacle having a space formed therein and coupled to the compartment of the housing via a conduit, for receiving the hydraulic fluid therein, and a piston slidably received in the space of the receptacle, to pump the hydraulic fluid to the actuator.

The pumping device includes a motorized device coupled to the piston, to move the piston relative to the receptacle, and to pump the hydraulic fluid between the space of the receptacle and the compartment of the housing. A coupler is coupled to the conduit, and includes a port provided thereon, for filling the hydraulic fluid into the conduit and then into the space of the receptacle and the compartment of the housing.

A pressure gauge may further be provided and coupled to the coupler, for detecting and watching a pressure within the conduit and the space of the receptacle and the compartment of the housing. A pressure regulator valve may further be provided and coupled to the coupler, for regulating a pressure within the conduit and the space of the receptacle and the compartment of the housing.

The pressure applying device includes a passage formed in the mold member and communicating with the mold cavity, and a pneumatic device coupled to the passage via a hose, for supplying a pressurized air to the mold cavity, and for forcing against the melted foamable material.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a mold device in accordance with the present invention;

FIG. 2 is a partial cross sectional view of the mold device;

FIG. 3 is another partial cross sectional view of the mold device, similar to FIG. 2, illustrating the operation of the mold device; and

FIG. 4 is a further partial cross sectional view illustrating the other arrangement of the mold device.

### DETAILED DESCRIPTION OF THE PREFERRED EMBODIMENT

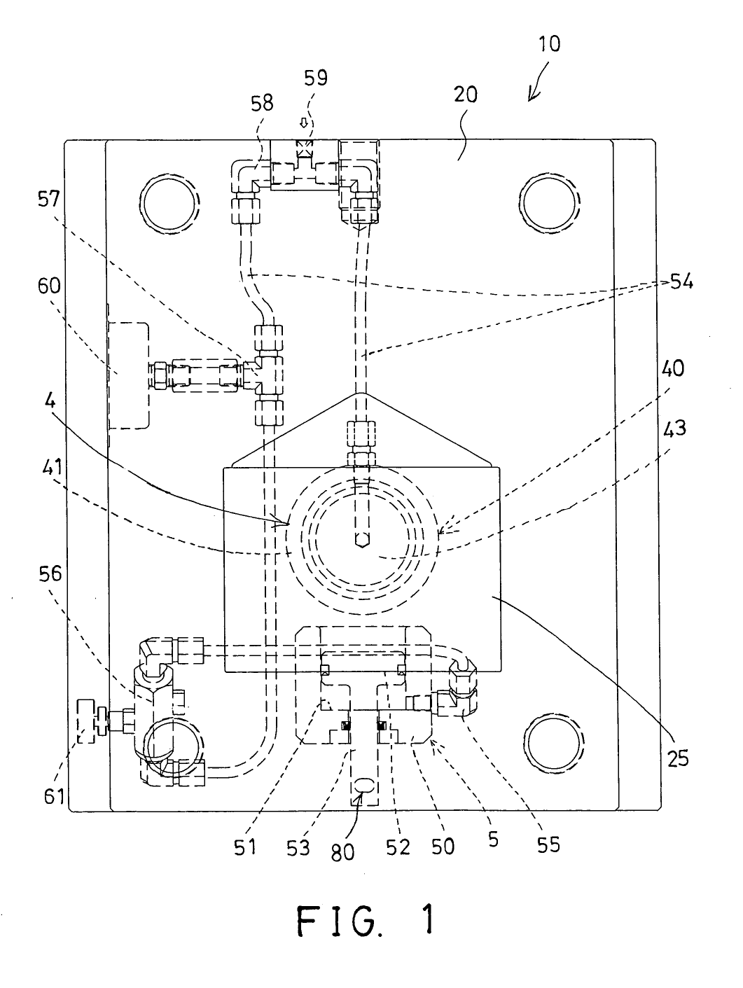

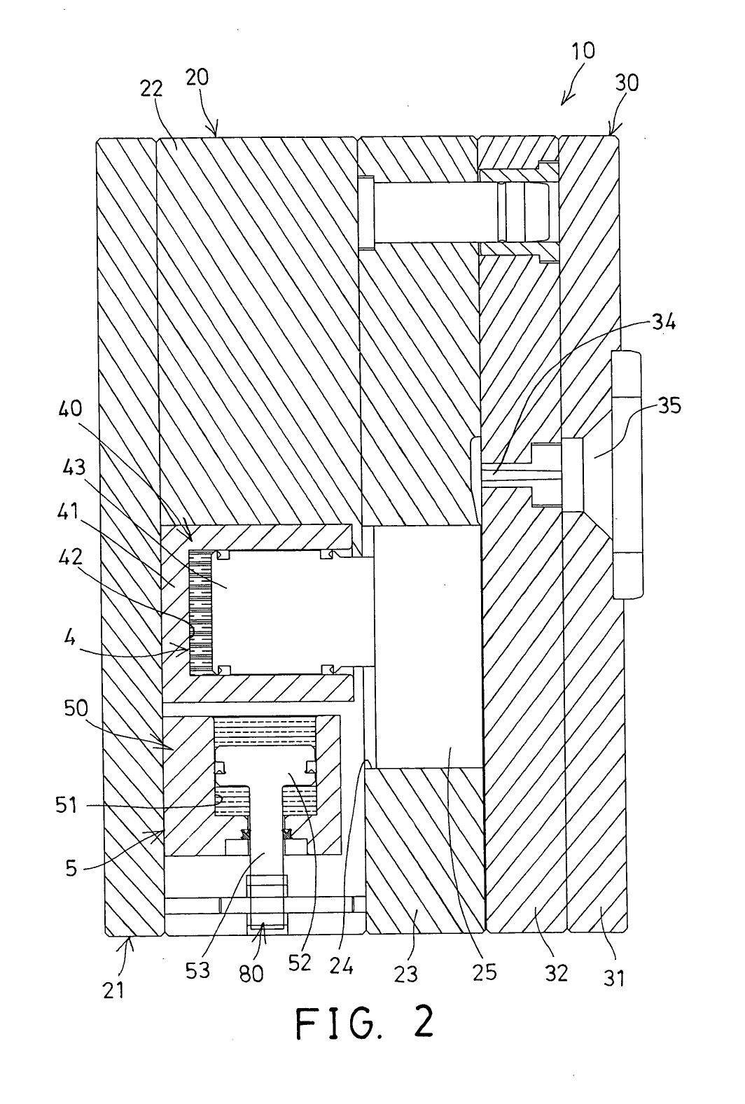

Referring to the drawings, and initially to FIGS. 1 and 2, a mold device 10 in accordance with the present invention comprises a lower or mother or first or female mold member 20 which may be formed or made of, for example, two or more mold elements 21, 22, 23, with such as fasteners or latches (not shown), or the like, and which includes one or more mold cavities 24 formed therein, each provided for slidably receiving a movable or slidable mold piece 25 therein.

The mold device 10 further includes an upper or daughter or second or male mold member 30 which may also be formed or made of two or more mold elements 31, 32, with such as fasteners or latches (not shown), or the like, in which the mold piece 25 is movable or slidable relative to the second or male mold member 30, to partially expose the mold cavity 24 or to form a chamber 33 between the mold members 20, 30 and the movable or slidable mold piece 25. The mold members 20, 30 may also be solidly secured or formed integral together to form a one-integral single piece mold member.

The upper or daughter or second or male mold member 30 includes a pouring passage 34 formed therein and communicating with the chamber 33 formed or defined between the mold members 20, 30 and the movable or slidable mold piece 25, and having a pouring gate or spout 35 provided therein for receiving the melted plastic or foamable materials, and for allowing the melted plastic or foamable materials to be filled or injected into the chamber 33, or into the mold cavity 24 of the mold member 20.

The mold device 10 further includes a pressurizing means or device 4 for applying a force or compression pressure onto or against the melted plastic or foamable materials filled or injected into the chamber 33 defined between the mold members 20, 30 and the mold piece 25, or into the mold cavity 24 of the mold member 20. For example, the pressurizing means or device 4 includes an actuator 40 for applying the force or compression pressure onto or against the melted plastic or foamable materials.

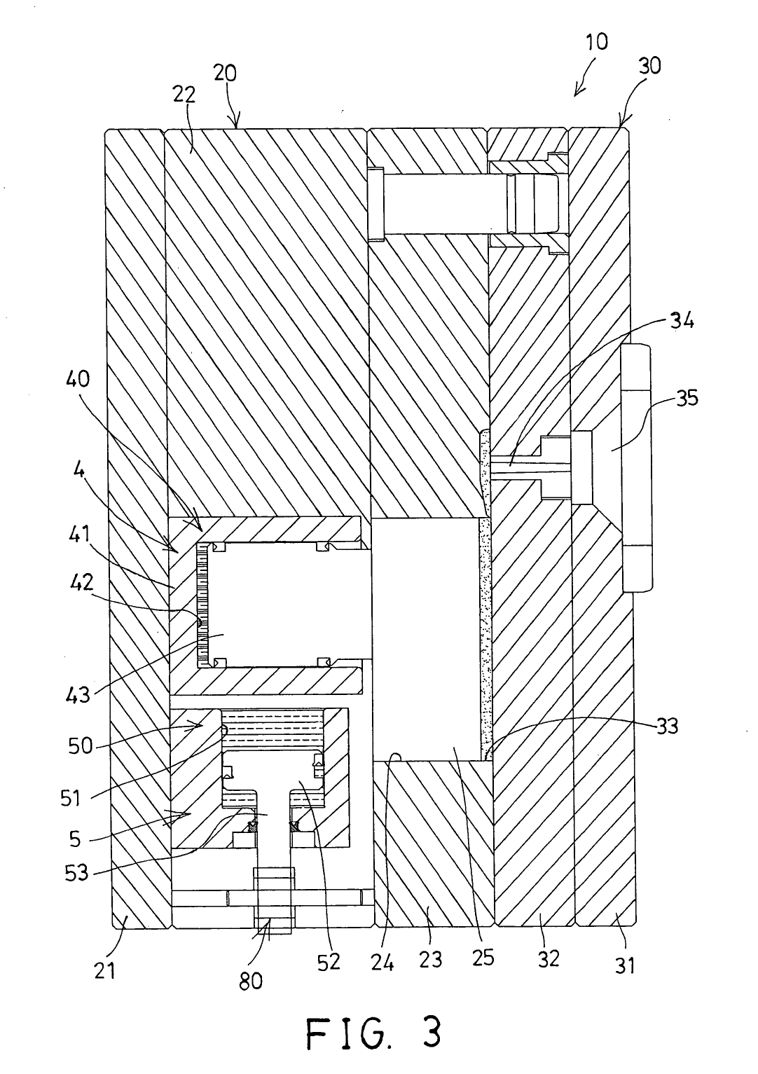

As shown in FIGS. 2 and 3, the actuator 40 includes a housing 41 having a chamber or compartment 42 formed therein for receiving hydraulic oil or fluid therein, and a shank 43 slidably received in the chamber or compartment 42 of the housing 41 and contactable or engageable with the movable or slidable mold piece 25, for applying the force or compression pressure onto or against the mold piece 25, and then onto the melted plastic or foamable materials.

The pressurizing means or device 4 further includes a forcing or pumping means or device 5 coupled to the actuator 40, for forcing or pumping the hydraulic oil or fluid into the chamber or compartment 42 of the housing 41, and for allowing the hydraulic oil or fluid to flow back from the chamber or compartment 42 of the housing 41 toward the forcing or pumping means or device 5. For example, the forcing or pumping means or device 5 includes a receptacle 50 having a chamber or space 51 formed therein for receiving the hydraulic oil or fluid therein, and a piston 52 slidably received in the space 51 of the receptacle 50, to force or to pump the hydraulic oil or fluid to the pressurizing device 4.

For example, the piston 52 of the forcing or pumping device 5 includes a piston rod 53 extended therefrom, for coupling to a motor, or various motorized devices 80, which may be used to move the piston 52 relative to the receptacle 50, in order to force or to pump the hydraulic oil or fluid to the pressurizing device 4, or to draw the hydraulic oil or fluid backward from the space 51 of the receptacle 50 to the chamber or compartment 42 of the housing 41 of the pressurizing device 4. The pressurizing device 4 and the forcing or pumping device 5 may be disposed in or out of the mold members 20, 30.

As shown in FIG. 1, a manifold or conduit 54 may be formed or provided or coupled between the chamber or compartment 42 of the housing 41 and the space 51 of the receptacle 50, for allowing the hydraulic oil or fluid to flow between the space 51 of the receptacle 50 and the chamber or compartment 42 of the housing 41 of the pressurizing device 4. An elbow 55 may be coupled to the space 51 of the receptacle 50, two U-shaped couplers 56, 58 and a T-shaped coupler 57 may be coupled between the elbow 55 and the chamber or compartment 42 of the housing 41, for forming or coupling the manifold or conduit 54 between the housing 41 and the receptacle 50.

The U-shaped coupler 58 may include a port 59 provided thereon, for filling the hydraulic oil or fluid into the manifold or conduit 54 and then into the space 51 of the receptacle 50 and the chamber or compartment 42 of the housing 41. A pressure gauge 60 may be coupled to the T-shaped coupler 57, for detecting or watching the pressure within the manifold or conduit 54 and/or within the space 51 of the receptacle 50 and/or within the chamber or compartment 42 of the housing 41.

A pressure regulator valve 61 may be coupled to the U-shaped coupler 56, for adjusting or regulating the pressure within the manifold or conduit 54 and/or within the space 51 of the receptacle 50 and/or within the chamber or compartment 42 of the housing 41. The pressure regulator valve 61 and the motor or motorized devices 80 may thus be used to regulate or to adjust the actuator 40 to applied the predetermined force or pressure to or against the mold piece 25 and thus the melted plastic or foamable materials.

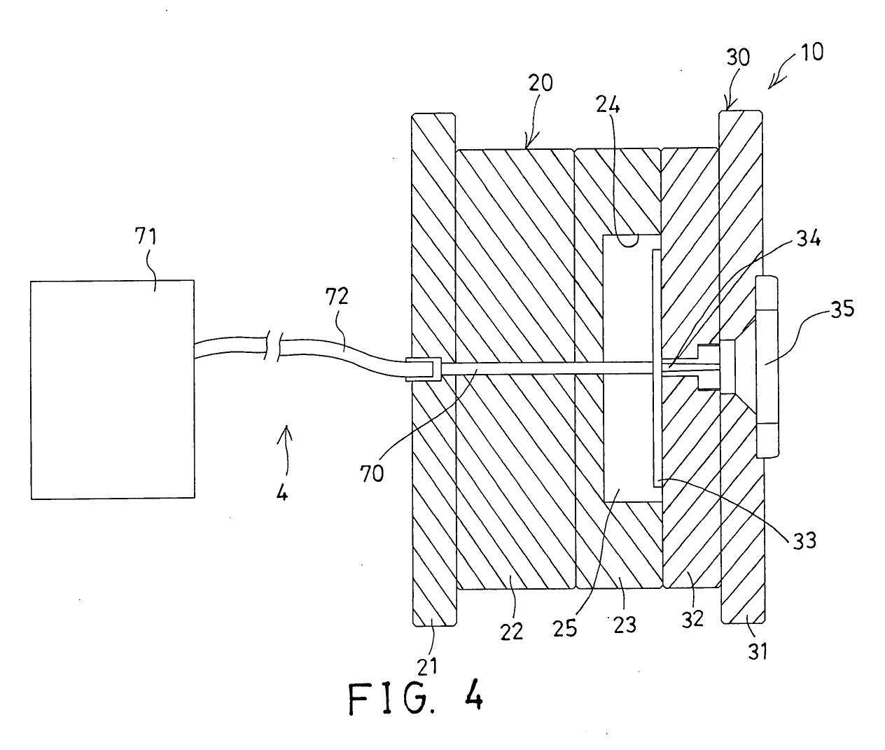

Alternatively, as shown in FIG. 4, the pressurizing device 4 may include a passage 70 formed in both the mold member 20 and the mold piece 25, and communicating with the chamber 33 formed or defined between the mold members 20, 30 and the mold piece 25, or between the mold member 30 and the mold piece 25, and coupled to a pressurized air supplying reservoir or device or a pneumatic device 71 via a hose 72, for allowing the pressurized air to be supplied into the chamber 33, to apply the force or compression pressure onto or against the melted plastic or foamable materials filled or injected within the chamber 33 formed between the mold member 30 and the mold piece 25.

In operation, as shown in FIG. 2, the forcing or pumping device 5 may force the hydraulic oil or fluid to the chamber or compartment 42 of the housing 41, and to force the shank 43 to act onto the movable or slidable mold piece 25, and to apply the force or compression pressure, such as 70 bars, onto or against the mold piece 25, and then to apply the force or compression pressure onto the melted plastic or foamable materials, to force the melted plastic or foamable materials to be foamed and to generate micro bubbles, and to prevent the bubbles from being broken, and to prevent the perforations or orifices from being formed in the outer peripheral portion of the objects to be formed or made with the foamable materials. The stiffness of the objects may also be increased or facilitated.

Accordingly, the mold device in accordance with the present invention includes a structure arranged for pressurizing foamable materials, and for preventing the foamable materials from being over foamed, and for preventing perforations or orifices from being formed in the outer peripheral portion of the objects to be formed or made with the foamable materials.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A mold device comprising:
a mold member including a mold cavity formed therein for receiving a melted foamable material therein to form an object, and
a pressure applying means for applying a pressure to the melted foamable material, and to limit a foaming of the melted foamable material, and for preventing orifices from being formed in an outer peripheral portion of the object.

2. The mold device as claimed in claim 1, wherein said pressure applying means includes a mold piece movably received in said mold cavity of said mold member, to form a chamber between said mold member and said mold piece, and for receiving the melted foamable material therein.

3. The mold device as claimed in claim 2, wherein said mold member includes a pouring passage formed therein and communicating with said chamber formed between said mold member and said mold piece, and having a pouring spout provided therein for receiving and filling the melted foamable material into said chamber formed between said mold member and said mold piece.

4. The mold device as claimed in claim 2, wherein said pressure applying means includes an actuator engageable with said mold piece, for forcing said mold piece to force against the melted foamable material.

5. The mold device as claimed in claim 4, wherein said actuator includes a housing having a compartment formed therein for receiving a hydraulic fluid therein, and a shank slidably received in said compartment of said housing and engageable with said mold piece, for forcing against said mold piece, and then onto the melted foamable material.

6. The mold device as claimed in claim 5, wherein said pressure applying means includes a pumping device coupled to said compartment of said housing, for pumping the hydraulic fluid into and out of said compartment of said housing.

7. The mold device as claimed in claim 6, wherein said pumping device includes a receptacle having a space formed therein and coupled to said compartment of said housing via a conduit, for receiving the hydraulic fluid therein, and a piston slidably received in said space of said receptacle, to pump the hydraulic fluid to said actuator.

8. The mold device as claimed in claim 7, wherein said pumping device includes a motorized device coupled to said piston, to move said piston relative to said receptacle, and to pump the hydraulic fluid between said space of said receptacle and said compartment of said housing.

9. The mold device as claimed in claim 7, wherein a coupler is coupled to said conduit, and includes a port provided thereon, for filling the hydraulic fluid into said conduit and then into said space of said receptacle and said compartment of said housing.

10. The mold device as claimed in claim 7, wherein a coupler is coupled to said conduit, and includes a pressure gauge coupled to said coupler, for detecting and watching a pressure within said conduit and said space of said receptacle and said compartment of said housing.

11. The mold device as claimed in claim 7, wherein a coupler is coupled to said conduit, and includes a pressure regulator valve coupled to said coupler, for regulating a pressure within said conduit and said space of said receptacle and said compartment of said housing.

12. The mold device as claimed in claim 1, wherein said pressure applying means includes a passage formed in said mold member and communicating with said mold cavity, and a pneumatic device coupled to said passage via a hose, for supplying a pressurized air to said mold cavity, and for forcing against the melted foamable material.
